(19) United States
(12) Patent Application Publication
(10) Pub. No.: US 2005/0274128 A1
(43) Pub. Date: Dec. 15, 2005

(54) Cryopump with enhanced hydrogen pumping

(75) Inventors: Huruli Kishorenath, Fremont, CA (US); Vladislav Kalenyuk, Citrus Heights, CA (US)

Correspondence Address: STANLEY Z COLE, 26620 ST FRANCIS ROAD, LOS ALTOS HILLS, CA, 94022, US

(73) Assignee: GENESIS

(21) Appl. No.: 10/866,436

(22) Filed: Jun. 10, 2004

(51) Int. Cl. B01D 8/00

(52) U.S. Cl. 62/55.5

(57) ABSTRACT

This invention is a cryopump for enhanced removal of hydrogen from a vacuum environment. This is achieved through the use of a second stage made readily available to the gases being removed from the vacuum chamber. A plate that is part of the second stage is positioned with opening slots at an end of the stage near the chamber being evacuated. Extending outwardly from said slotted plate, are fins coated with charcoal. The charcoal tends to selectively deplete the hydrogen from gas being evacuated and the arrangement of the openings in the plate and the positioning of the fins readily permits and facilitates the movement of gas being treated across the fins where the hydrogen is readily removed.

### FIELD OF THE INVENTION

The present invention relates to enhanced hydrogen pumping by cryogenic pumps and improved speed stability over the capacity range of such pumps.

### BACKGROUND OF THE INVENTION

Cryogenic vacuum pumps (also referred to as cryopumps) provide clean, reliable, high-speed vacuum pumping and are widely used in high vacuum applications. Cryopumps are based on the principle of removing gases from a vacuum chamber by condensing gases present in the chamber onto cold surfaces and this may or may not include deposition onto previously condensed gas molecules. For gas molecules that do not readily bind, sorbent materials such as charcoal may be used within the vacuum environment for purposes of condensing and adhering gas particles that have not otherwise been removed. One can also use cryotrapping to pump gases that are difficult to condense. In this case a sorbent gas is admitted into the pump and forms a condensate on the cold surface. The difficult to condense gas is also admitted and is absorbed on the newly formed surface of easily condensable gas forming a mixed condensate.

Since cryopumping is an exceedingly clean vacuum generating process, cryopumps are typically used in semiconductor processing equipment where high levels of vacuum are required and cleanliness is of paramount importance. In semiconductor applications cryopumps are used to deliver one or more of the following: good base pressures; high gas throughputs; high impulsive gas loads; high gas pumping capacities; pressure and speed stabilities over a broad range of gas loads; fast cool-downs; and, fast regenerations. A recent trend is to integrate the cryopump and cryo compressor controls with the controls of the process systems since this enables one operating the process system to efficiently employ the cryopump and cryo compressor during the operation of the process. There is also increased demand for larger compressors to handle multi-pump systems and controls for such units are also best placed at the point of control for the process systems.

Cryopumps can only operate at low pressures, and hence generally operate in conjunction with a roughing pump. The roughing pump reduces the pressure in the system to a pressure of about 30-100 microns before the cryopump is actuated. Even the inner volume of the cryopump enclosure needs to be evacuated to low pressures before both first and second stage arrays are taken to lower temperatures.

Cryopumps which are dependent on cold internal surfaces typically use a closed loop helium refrigerator to achieve the desired internal temperatures. The refrigerator includes an expander that creates cryogenic refrigeration by the controlled expansion of compressed helium. The refrigerator may be powered by an AC synchronous stepper motor that maintains a constant rotating speed under varying load conditions. This allows refrigeration power to remain stable when line power conditions fluctuate. The refrigerator is designed to provide maximum refrigeration at standard line power conditions. Cryopumps typically include one or two stages. In a two stage cryopump, refrigeration is produced in a first stage operating at 50K to 80K and in a second stage operating at 10K to 20K. Thermally conductive surfaces called cryoarrays are thermally connected to the stages of the expander and are cooled by them.

The refrigerator may be powered by an AC synchronous stepper motor that maintains a constant rotating speed under varying load conditions. This allows refrigeration power to remain stable when line power conditions fluctuate. The refrigerator is designed to provide maximum refrigeration at standard line power conditions.

In a typical semiconductor fabrication process, wafers are processed within a chamber. A valve connecting the cryopump to the chamber remains closed while the wafer is placed in the chamber since this can and generally is done at higher temperatures. The chamber is sealed and a roughing pump is used to reduce pressure within the chamber to a vacuum level suitable for operations with a cryopump. The valve separating the cryopump from the chamber is then opened, to pump the chamber to the degree of vacuum required for processing. The process may, for example, include the implantation of ions (e.g., arsenic, phosphorus, or boron) into the wafer. The ions are contained in a carrier gas, typically hydrogen.

The cryopump can be a one stage or a two stage unit. One stage units are commonly used to condense water vapor and other gases with high vapor pressures. Two stage units are used to remove all gases from a vacuum chamber. These gases are condensed or absorbed onto thermally conductive first and second stage arrays attached to the first and second stages of the expander, respectively.

Cryopumps are commonly used in sputtering and in ion implantation applications. Sputtering applications involve relatively high pressures and a continuous flow of argon. In this application, the temperature of the first stage must be within certain limits for proper operation. The coldest area of the first stage should not reach temperatures below about 55K to 60K. If the first stage reaches a lower temperature, gases that are normally present such as nitrogen and argon will temporarily condense on the first stage surfaces. These gases will then slowly migrate to the second stage, causing a phenomenon known as nitrogen or argon “hang up”. When the first stage is held at about 55K to 60K or higher, the first stage does not pump these gases and nitrogen and argon hang up is avoided. Pumps used in sputtering applications also encounter higher radiation loads due to chamber bake out.

In ion implanter applications, processes occur at higher vacuum levels. The pumps for this application need to have high capacity for hydrogen and very high hydrogen pumping speeds. Pumps supplied to the ion implanter industry have generally been high vacuum cryopumps. To date however, pumps in this industry have not been refined or designed to specifically address the unique needs of ion implantation systems. The purpose of this invention is to address this need and define improved pumps for the pumping of hydrogen and as a result improve the atmosphere within ion implanters as to achieve improved pumping speeds, performance and operations of cryopumps for ion implanters.

### SUMMARY OF THE INVENTION

This invention is concerned with increasing the hydrogen pumping speed in cryopumps with second stage refrigeration power of generally 5 watts or less, as well as improving the speed stability for a large gas throughput. However, the principles of operations applicable for this pumping power are also applicable to pumps of greater power. Hydrogen is pumped by cryopumps by cryo-adsorbtion onto charcoal present at the second stage of these pumps. The charcoal in these arrays is bonded onto metal fins and is held at temperatures below 20K. However, any cold surface which captures hydrogen can also pump higher vapor pressure gases. Accordingly and to prevent the charcoal from loading-up by pumping higher vapor pressure gases, the charcoal is generally tucked under a metal plate which is also held at second stage temperatures. This type of array is appropriate where higher hydrogen capacity in the pumped gases is of importance and speed is not the main requirement. This “hiding” of the charcoal however, has a negative effect, in process situations where higher hydrogen pumping speed is required. The effective transmission coefficient for hydrogen in this design with the charcoal tucked under the metal plate is in the range of 15% of the theoretical maximum. In the proposed design of cryopumps in accordance with this invention, the second stage array is constructed to give more gas conductance to the charcoal. More particularly since the charcoal is the effective medium for removal of the hydrogen, the purpose is to arrange for the charcoal to be more exposed to the gas in the second stage. In order to achieve this higher conductance, the fins of this array are lined up vertically and perpendicularly to the pump top flange and the top second stage plate is slotted so as to create extra paths as compared to existing pumps for lower vapor pressure gases to get to the charcoal surfaces. By mounting the fins vertically, all the fins are made accessible to the hydrogen incoming both from the sides and through the slots. By providing a slotted 20K top plate, gases like nitrogen and argon are easily pumped on this plate thus keeping the charcoal surface available for hydrogen pumping. Because of the openness of the array, some of the higher vapor pressure gases also find their way onto the charcoal. By providing enough charcoal to achieve the desired hydrogen capacity, accumulation of these other gases on the charcoal surface has proven to have no adverse effect on hydrogen pumping speed by the cryopump. This vertical fin arrangement coupled with the slotted plate also makes it possible for the cryopump to achieve a much flatter speed-capacity curve which in turn results in better process stability.

### BRIEF DESCRIPTION OF THE DRAWINGS

FIG. 1 is a schematic illustration of a prior art cryopump arrangement.

FIG. 2 includes two schematic illustrations. A prior art array is shown in FIG. 2A and an array in accordance with this invention is illustrated in FIG. 2B.

FIG. 3 is a schematic illustration of a cryopump in accordance with this invention. This is shown in a top and side view identified as 3A and 3B respectively.

FIG. 4 is a set of curves showing the comparative pumping results of the pump of this invention compared to results achieved with a typical prior art pump.

### DETAILED DESCRIPTION OF THE DRAWINGS

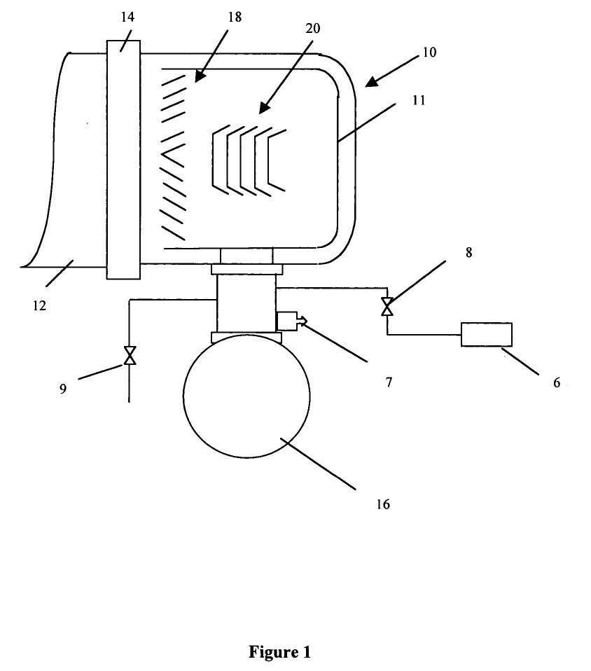

In FIG. 1 there is shown a cryopump 10 with an inlet attached to a vacuum chamber 12 through a high vacuum valve 14. The vacuum chamber 12 (shown partially in this Figure) is capable of maintaining a high vacuum for use in performing vacuum processing of a workpiece. Thus this processing chamber may comprise a sputter deposition system or other vacuum processing station. Cryopump 10 includes a refrigerator 16 in thermal contact with a first stage cryoarray 18 and with a second stage cryoarray 20. A roughing valve 8 is in the line connecting roughing pump 6 to cryopump 10. A purge valve 9 is used in regenerating the pump and relief valve 7 releases gases from the pump during regeneration.

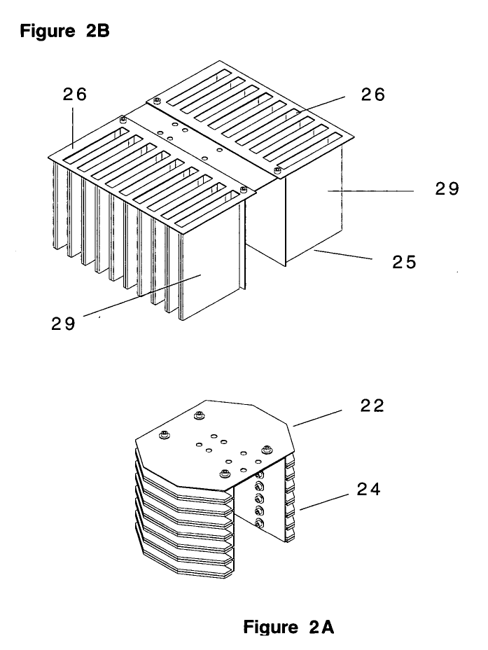

FIG. 2A illustrates the type of array that is commonly in use today. It includes a top plate 22 (in FIG. 1 this may comprise the line at the left in the group designated 20 in the central area), and an array of horizontal fins 24 (these correspond with the fins shown in the second array 20 of FIG. 1 and generally comprise the fins that are located below the top plate or the fin to left in the group designated 20). The top plate 22 (and its equivalent in FIG. 1) is a solid member that is maintained at a temperature of approximately 10K to 20K. Plate 22 functions by absorbing nitrogen and argon, the lower vapor pressure gases. The array itself is shaped like an inverted U. The fins extend outwardly on each side of the downwardly extending arms. The fins are coated on the both sides with charcoal for removing the lower pressure gases. Gases enter the chamber of the pump and gradually flow down past the upper solid plate to the fins below. The solid plate 22 however, acts as an impediment to the flow of gas to the charcoal in order to prevent nitrogen or argon hang up in the second stage. Although variations may exist in the industry the various pumps that are available all are structured to make it difficult for the gases to reach the fins of the array. In the array under discussion, the solid plate 22 is the most effective element in blocking gases by causing gases to flow around this plate in order to reach the charcoal fins below. Fins extending in a parallel relationship with the top plate are also positioned so that gases do not readily reach the fins. In other structures other means to impede the flow of hydrogen to the charcoal are used. For example if the charcoal is on a distinct member, for example, a sheath with controlled openings is positioned around this member as to make the charcoal surfaces inaccessible to the gas flow within the pump body. If the charcoal surfaces were readily available to the gases within the body of the pump and if no effort were made to change other elements of the pump, the charcoal surfaces could be expected to load up with higher vapor pressure gases and be unavailable for the lower vapor pressure gases with the result that such pumps would not pump lower vapor gases such as hydrogen efficiently. Even though charcoal fins are available for hydrogen pumping in existing pumps, the effective transmission coefficient for hydrogen in these pumps is in the range of 15% of the theoretical maximum or they effectively pump about only 15% of the hydrogen available for pumping.

In FIG. 2B is illustrated an array in accordance with this invention. The top plate 26 is slotted. Gas within the pump body thus can pass more readily through this plate than is the case in prior art pumps requiring the gas to pass around the upper plate to pass to the surfaces below. Extending downwardly from the slotted top are vertical fins 25. The fins are coated with charcoal 29 on both surfaces. They are mounted to extend downward from the solid sections of slotted plates 24. The fins are spaced from one another so as to provide access for hydrogen molecules to the charcoal coated surfaces and at the same time to accommodate a large number of fins to provide adequate hydrogen pumping surfaces. The fins 25 are connected (welded or bolted) to slotted plates 25. Slotted plates 25 permit the gases within the pump to readily reach the charcoal surfaces 29 on the surfaces of the fins 25. Thus in this array, unlike the prior art arrays, gas flow is facilitated so that gas may move through the system unimpeded and readily reach the charcoal surfaces 29. In this way the pump removes hydrogen at a faster rate and to a greater extent, and at a more stable rate. In part this is achieved by providing a greater surface area of charcoal 29 for absorption of gases. This comes about because of the close spacing of the charcoal covered fins which permits absorption of additional higher pressure gases by the charcoal while providing more surface area readily available to also absorb lower pressure gases without loading up. The slotted plate helps and the downward extending fins also contribute. The result is a pump with an efficiency of at least about a 20% transmission coefficient for hydrogen gases. In this field this is about a one-third improvement over what has generally been available.

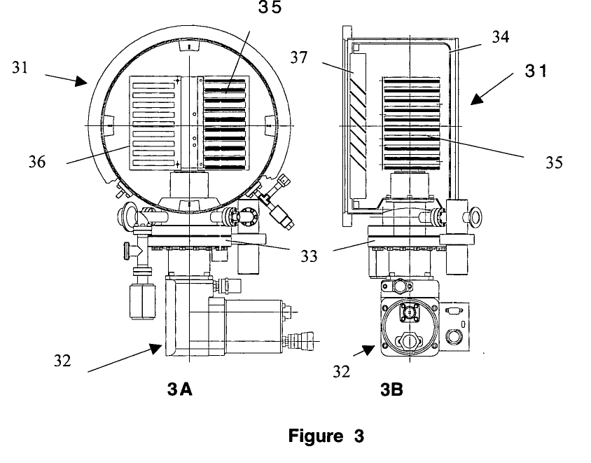

FIG. 3 shows a top view in FIG. 3A of the present invention. In FIG. 3B is shown a side view of the pump illustrated in FIG. 3A. The pump body 31 is connected to the refrigerator 32 through a flange 33. The first stage array 34 is connected to baffle 37. Baffle 37 in essence pumps the water vapors out of the gases being pumped through the pump. In the illustrated pump the area of the baffles would be connected to the chamber intended for vacuum processing of workpieces (in FIG. 1 shown as 12) and could have a valve control (such as 14 in FIG. 1) between it and the vacuum processing unit. The first and second stage arrays are connected to adapters and to refrigerator 32 and are thereby brought to temperature. A slotted cooling plate 36 illustrated only on the left side of the pump, is connected to the second stage array 35. This slotted plate is shown only on the left side so that a view of the charcoal coated copper fins positioned below the slotted plate can be seen on the other side in this top view. In fact however, in a completed pump a slotted plate 36 would also appear covering the fins on the right side of the pump in the view shown in FIG. 3A. Baffle 37 has the additional function of giving the pump enhanced speed without exposing the second stage array to high radiation loads from the chamber. The vertical fins 35, the slotted plate 36 and the baffle 37 together result in greater hydrogen pumping speed than has been available in this art.

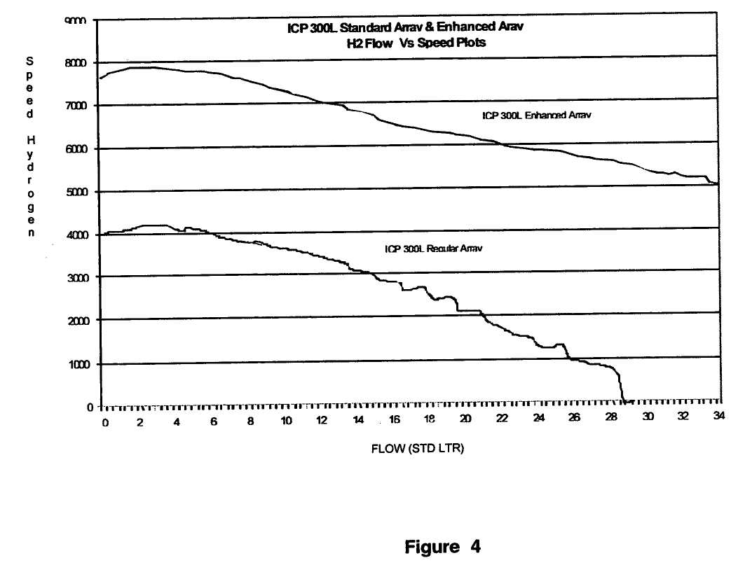

Referring now to FIG. 4, there is shown a comparative set of plots. The lower plot shows a plot of “Flow Vs Speed” for a pump with a standard array and the upper plot is a like curve for the enhanced system of the present invention. The test setups were as per AVS standards. The segment of this graph showing the speed of hydrogen pumped is in liters/second for both curves and the hydrogen measurement is of H₂ By studying the two graphs, it is evident that the enhanced array achieves a higher hydrogen pumping speed, and also greater stability over a longer flow duration. The standard array (lower curve), shows slightly more than 4000 Itr/sec speed for the first 6 standard liters of flow and then falls sharply to its end of life (half the original speed) by the time the flow reaches 21.6 standard liter. The enhanced array (upper curve), on the other hand, shows remarkable stability throughout its life. The speed peaks at 7860 standard liter and stays above 6000 standard liter until the flow reaches 22 standard liter of hydrogen. For the next 12 standard liter of flow, the speed drops by only 1000 Itr/sec. This comparison of results clearly demonstrates the remarkable improvement in the array performance achieved by the newly designed “Enhanced” array. The enhanced array used in making the curve of this Figure had a transmission coefficient for hydrogen of better than 20%.

While there has been shown and discussed what is presently considered a preferred embodiment, it will be obvious to those skilled in the art that various changes and modifications may be made without departing from the scope of this invention and the coverage of the appended claims.

1. A cryogenic pump for enhanced hydrogen pumping comprising
a pump body connected to a refrigerator, a first and second stage within said pump body, said second stage comprising a slotted plate at an end thereof and cooling fins extending outwardly from said plate as to readily permit gas flow through said slots and across said fins, each said stage being connected to said refrigerator with said first stage set to be cooled by said refrigerator within the range of about 50K to about 80K and said second stage from about 10K to about 20K, said fins of said second stage being coated with charcoal to remove hydrogen from gas within the vacuum created by said pump, said first stage arranged to first remove water vapors from gas in the vacuum before passing the remaining gas across said slotted plate and said cooling fins.

2. The cryogenic pump of claim 1 in which said slotted plate is positioned at the top of said second stage and in which said fins extend in one direction from said plate.

3. The cryogenic pump of claim 2 in which said extending fins are joined to said slotted plate as to provide unimpeded gas flow through said slots and to and across said fins.

4. The cryogenic pump of claim 3 in which said fins extend downwardly from said plate into said pump body.

5. A cryogenic pump for enhanced hydrogen pumping comprising
a pump body connected to a source of refrigeration, a first and second stage within said pump body, said second stage comprising a member at an end thereof with open areas throughout and cooling fins extending outwardly in one direction therefrom as to readily permit gas flow through said open areas and across said fins, each said stage being connected to said refrigerator with said first stage set to be cooled by said refrigerator within the range of about 50K to about 80K and said second stage from about 10K to about 20K, said fins of said second stage being coated with charcoal to remove hydrogen from gas being removed from a chamber being pumped by said pump, said second stage having refrigeration power of about 5 watts, said first stage arranged to first remove water vapors from gas in the chmber before passing the remaining gas across said member and said cooling fins.

6. The pump of claim 1 in which said pump body has a grill-like opening at its entrance adjacent to the chamber to be evacuated, said grill-like opening being connected to said source of refrigeration as part of said first stage.

7. The pump of claim 5 in which said grill-like opening is maintained at a temperature to remove water vapors from gas being pumped by said cryogenic pump.

8. The pump of claim 6 in which said plate of said second stage is positioned within said pump body first in the path of said incoming pumped gases from the chamber being evacuated after passage of said gas through said grill-like opening, and said fins are positioned to extend downwardly from said plate as to make said charcoal fins readily available to gas passing through said plate within said pump body to enhance the removal of hydrogen from the chamber being evacuated.

9. The method of enhancing the pumping of hydrogen from a chamber being evacuated by a cryopump comprising pumping gas from the chamber after reducing the pressure within the chamber with a roughing pump, pumping gas from the chamber with a cryopump connected through a valve to the chamber through a baffle held at said first stage temperature, flowing unimpeded pumped gas within said pump across a slotted plate of said second stage, and flowing unimpeded pumped gas from said plate to and across charcoal coated fins held at the second stage temperature.

10. The method of claim 9 in which an adequate supply of charcoal is readily available on the fins to rapidly and consistently remove hydrogen gas from the gas being evacuated.

11. The pump of claim 8 including means to regenerate said pump.
